(19) United States
(12) Patent Application Publication
(10) Pub. No.: US 2016/0222323 A1
(43) Pub. Date: Aug. 4, 2016

(54) METHOD OF DISHWASHING

(71) Applicant: The Procter & Gamble Company, Cincinnati, OH (US)

(72) Inventors: Nathalie Sophie LETZELTER, Trimdon (GB); Fernando SOLACHE LEON, Newcastle upon Tyne (GB); Claire URQUHART, Bedlington (GB)

(21) Appl. No.: 15/008,474

(22) Filed: Jan. 28, 2016

(30) Foreign Application Priority Data
Feb. 2, 2015 (EP) 15153515.0

(51) Int. Cl. C11D 3/39; C11D 17/04; C11D 3/20; C11D 17/06

(52) U.S. Cl. CPC C11D 3/3932; C11D 17/06; C11D 17/044; C11D 3/2086

(57) ABSTRACT

A method of automatic dishwashing comprising the step of delivering into a dishwasher a cleaning product comprising a particulate loose-powder composition comprising an organic complexing agent, bleach, manganese bleach catalyst and free of phosphate and wherein the manganese bleach catalyst is in the form of a delayed release particle.

### TECHNICAL FIELD

The present invention is in the field of automatic dishwashing. In particular, it relates to a method of automatic dishwashing using a product comprising complexing agent, bleach, and manganese bleach catalyst in particulate form. The composition provides very good removal of bleachable stains.

### BACKGROUND OF THE INVENTION

The automatic dishwashing detergent formulator is continuously looking for ways to improve automatic dishwashing. Items placed in a dishwasher to be washed are usually stained with different kinds of stains. Tea and coffee stains are particularly difficult to remove. The problem is more acute when the detergent is phosphate free.

Bleaching performance can be improved by the use of metal bleach catalysts. Some of the components of automatic dishwashing detergents can interact with the bleach catalyst thereby reducing its efficacy.

Catalysts and other minor detergent components, such as glass care agents are present in detergent compositions in very low levels. Problems associated with the use of such small quantities include inaccurate dosage and heterogeneous distribution of the components throughout the composition. Lack of homogeneity in the distribution of the components may result in an inconsistent performance of the detergent composition. In the case of powder compositions it is difficult to avoid segregation and make sure that the correct level of each component is consistently found in each detergent dose.

A great amount of work has been done to try to overcome the instability issue related to manganese catalysts and a large number of patents have been filed to address the instability issues associated to manganese catalysts, see for example WO95/30733 and WO2009/40545.

An additional problem associated to bleach catalyst is that they can generate free radicals that can affect the chemical stability of the detergent. Lately, automatic dishwashing detergents are presented in unit dose form. Many of the unitised dose detergents are wrapped in water soluble films. The free radicals generated by the bleach catalyst can attack the film affecting not only the stability of the film but also the stability of the entire product.

The objective of the present invention is to try to overcome the above mentioned problems.

### SUMMARY OF THE INVENTION

According to a first aspect of the invention, there is provided a method of automatic dishwashing, i.e., a method of cleaning soiled dishware and tableware in a dishwasher. The method comprises the step of delivering into a dishwasher, preferably into the main wash of a dishwasher, a cleaning product.

Usually dishwashing programs have a pre-rinse, in which the ware is only rinsed with water, a main wash, in which the ware is washed with detergent and one or more subsequent rinses. The detergent is usually placed in the dispenser of the dishwasher and automatically delivered into the main wash.

The cleaning product comprises a particulate composition. The particulate composition is in the form of loose powder. By “loose-powder” is herein meant a powder comprising a plurality of independent particles, i.e., the particles are not bound to one another. When the loose powder is delivered into the dishwasher the particles in the wash liquor are found as individual entities rather than in the form of a single entity constituted by a plurality of particles. The particulate loose-powder can be enveloped by a water-soluble wrapping or encasing material such as a water-soluble film or an injection-moulded container. Particulate loose-powder wrapped in water-soluble material is considered “loose powder” for the purpose of the invention because once the enveloping water-soluble material is dissolved the particles are found in the wash liquor as individual entities. Pressed tablets are not considered a product comprising a particulate loose powder composition.

The composition is free of phosphate and comprises a complexing agent, bleach, and a manganese bleach catalyst. The complexing agent, bleach, manganese bleach catalyst and preferably other optional constituents of the composition are preferably present in separate particles although some of them can also be present in the same particle.

Without being bound by theory, it is believed that complexing agents can reduce the efficacy of the manganese bleach catalyst. It is believed that the complexing agent can sequester manganese thereby reducing the amount of catalyst available to catalyse the bleach. In the present invention, the manganese bleach catalyst particle provides delayed release of the manganese bleach catalyst. This delayed release involves less manganese available at the beginning of the wash. At the beginning of the wash when there is no much manganese bleach catalyst available, the complexing agent would preferentially complex ions coming from the water hardness, other ingredients of the detergent and the soils instead of the manganese catalyst. By delaying the delivery of the manganese bleach catalyst there would be less free complexing agent present in the wash liquor when the manganese catalyst is released, thus the probability of the manganese bleach catalyst to be sequestered will be reduced and it will be available to catalyse the bleach and this is translated in an improvement on the removal of bleachable stains.

The manganese bleach catalyst is in the form of a delayed-release particle. By “delayed release” manganese bleach catalyst particle is herein meant a particle containing manganese bleach catalyst which delivers less than 70% of the total manganese to the wash liquor within the first minute, preferably within the second minute in which the particle is in the wash liquor using a Miele GSL dishwashing machine in a normal R-50° C. cycle (no pre-wash). Preferably more than 90% of the total manganese is delivered to the wash liquor in less than 5 minutes. The dissolution profile of the particle of the invention is such that only a small amount of manganese is released when the particle is delivered into the wash liquor. Most of the manganese bleach catalyst is delivered with a reasonable time, for example within less than 4 minutes thus the manganese bleach catalyst has enough time to catalyse the bleach. It has been surprisingly found that this dissolution profile provides optimum cleaning.

The complexing agent is preferably in particulate form. More preferably in the form of a fast dissolving particle, by “fast dissolving particle” is herein meant a particle that delivers more than 50%, preferably more than 60% and especially more than 70% of the total complexing agent to the wash liquor in the first minute in which the particle is in the wash liquor using a Miele GSL dishwashing machine in a normal R-50° C. cycle (no pre-wash). The fast dissolution of the complexing agent helps to quickly bind the metals from the water, detergent and the soil, this makes the cleaning conditions more favourable for the bleaching to take place.

By “free of phosphate” is herein understood that the composition comprises less than 1%, preferably less than 0.1% by weight of the composition of phosphate.

For the purpose of this invention a “complexing agent” is a compound capable of binding polyvalent ions such as calcium, magnesium, lead, copper, zinc, cadmium, mercury, manganese, iron, aluminium and other cationic polyvalent ions to form a water-soluble complex. The complexing agent has a logarithmic stability constant ([log K]) for Ca2+ of at least 5, preferably at least 6. The stability constant, log K, is measured in a solution of ionic strength of 0.1, at a temperature of 25° C.

The complexing agent is preferably selected from the group consisting of methyl-glycine-diacetic acid (MGDA), its salts and derivatives thereof, glutamic-N,N-diacetic acid (GLDA), its salts and derivatives thereof, iminodisuccinic acid (IDS), its salts and derivatives thereof, carboxy methyl inulin, its salts and derivatives thereof and mixtures thereof. Especially preferred complexing agent for use herein is selected from the group consisting of MGDA and salts thereof, especially preferred for use herein is the tri-sodium salt of MGDA.

Good cleaning and care results have been found when the manganese bleach catalyst particle comprises a bleach activator or a glass care agent, particularly when the particle comprises a bleach activator, in particular TAED, and a glass care agent, in particular a zinc-containing material, more in particular hydrozincite.

Preferably the composition of the method of the invention comprises from 5 to 20% by weight of the composition of bleach, more preferably the bleach is percarbonate.

Preferably, the loose powder of composition for use in the method of the invention is in unit-dose form. By “unit-dose form” is herein meant that the composition is provided in a form sufficient to provide enough detergent for one wash. Suitable unit dose forms include sachets, capsules, pouches, etc. Preferred for use herein are compositions in unit-dose form wrapped in water-soluble material, for example polyvinyl alcohol. The cleaning product detergent composition of the invention preferably weighs from about 8 to about 25 grams, preferably from about 10 to about 20 grams. This weight range fits comfortable in a dishwasher dispenser.

### BRIEF DESCRIPTION OF THE DRAWINGS

FIG. 1 discloses the manganese concentration in water over time in the wash.

### DETAIL DESCRIPTION OF THE INVENTION

The present invention encompasses a method of automatic dishwashing. The method involves the step of delivering a cleaning product into the dishwasher, preferably in the main wash. The product comprises a particulate composition, the composition is free of phosphate and comprises a complexing agent, preferably MGDA, bleach, preferably percarbonate and a delayed release manganese bleach catalyst particle. The delayed release of the manganese bleach catalyst improves the bleaching performance of the method of the invention.

### Manganese Bleach Catalyst Particle

The manganese bleach catalyst particle comprises a manganese bleach catalyst. The delivery of the manganese bleach catalyst from the particle into the wash liquor is such that less than 70% of the manganese is delivered within the first minute, preferably within the second minute in which the particle is in the wash liquor. The delivery of manganese into the wash liquor is assessed by using a Miele GSL dishwasher in a normal R-50° C. cycle. The product is automatically delivered from the dispenser of the dishwasher.

The particle preferably comprises from about 0.5 to about 5%, especially from about 1 to about 4% by weight of the particle of a manganese bleach catalyst. The particle preferably comprises from about 10 to about 80%, more preferably from about 20 to about 70% by weight of the particle of a bleach activator, preferably TAED. The particle preferably comprises from about 10 to about 80%, more preferably from about 20 to about 70% by weight of the particle of a glass care agent, preferably a zinc containing material, more preferably hydrozincite. Other preferred components of the particle are binders, processing aids and salts of organic acids.

### Manganese Bleach Catalyst

The bleach catalysts used in the context of the present invention are preferably bleach-boosting manganese salts or complexes of manganese. In the case of use of manganese salts, preference is given to manganese salts in the +2 or +3 oxidation states, for example manganese halides, preference being given to the chlorides, manganese sulfates, manganese salts of organic acids such as manganese acetates, manganese acetylacetonates, manganese oxalates and manganese nitrates.

The manganese complexes used with preference in the particle of the method of the invention are preferably complexes which contain, as macromolecular ligands, 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (MeMeTACN) and/or 2-methyl-1,4,7-triazacyclononane (Me/TACN) or bridged ligands such as 1,2-bis-(4,7-dimethyl-1,4,7-triazacyclonono-1-yl)ethane (Me4-DTNE) or derivatives of cyclam or cyclen, such as 1,8-dimethylcyclam, 1,7-dimethylcyclen, 1,8-diethylcyclam, 1,7-diethylcyclen, 1,8-dibenzylcyclam and 1,7-dibenzylcyclen.

Suitable manganese complexes are, for example, Mn^{III}2(μ-O)₁ (μ-OAc)₂(TACN)₂](PF₆)₂, [Mn^{IV}₂(μ-O)₃(Me-TACN)₂](PF₆)₂, [Mn^{IV}₂(μ-O)₃(Me-TACN)₂](SO₄), [Mn^{IV}₂(μ-O)₃(Me-TACN)₂](OAc)₂, [Mn^{IV}₂(μ-O)₃(Me-TACN)₂)(Cl)₂, [Mn^{IV}₂(μ-O)₃(Me4-DTE)](PF₆)₂, [Mn^{IV}₂(μ-O)₃(Me4-DTE)]Cl₂, [Mn^{IV}₂(μ-O)₃(Me4-DTE)](SO₄), [Mn^{IV}₂(μ-O)₃(Me4-DTE)](OAc)₂, cis(1,4,8,11-tetraazacyclotetradecane)dichloroiron(III) chloride, trans-(1,4,8,11-tetraazacyclotetradecane)dichloroiron(III)chloride, 1,8-diethyl-1,4,8,11 tetraazacyclotetradecaneiron(II)chloride, 1,8diethyl1,4,8,11tetraazacyclotetradecanemanganese(II)chloride and 1,4,8,11-tetraazacyclotetradecanemanganese(II) chloride.

Preferred manganese complexes are selected from [Mn^{III}₂(μ-O)₁(μ-OAc)₂(TACN)₂](PF₆)₂, [Mn^{IV}₂(μ-O)₃(Me-TACN)₂](PF₆)₂, [Mn^{IV}₂(μ-O)₃(Me-TACN)₂](SO₄), [Mn^{IV}₂(μ-O)₃(Me-TACN)₂(OAc)₂, [Mn^{IV}₂(μ-O)₃(Me-TACN)₂](Cl)₂, [Mn^{IV}₂(μ-O)₃(Me4-DTE)](PF₆)₂, [Mn^{IV}₂(μ-O)₃(Me4-DTE))Cl₂, [Mn^{IV}₂(μ-O)₃(Me4-DTE)(SO₄), [Mn^{IV}₂(μ-O)₃(Me4-DTE)](OAc)₂cis(1,4,8,IItetraazacyclotetradecane)dichloroiron(III)chloride, trans(1,4,8,11-tetraazacyclotetradecane)dichloroiron(III)chloride, 1,8-diethyl-1,4,8,11-tetrazacyclotetradecaneiron(II)chloride, 1,8diethyl1,4,8,11tetraazacyclotetradecanemanganese(II)chloride and 1,4,8,11-tetraazacyclotetradecanemanganese(II)chloride.

Especially preferred bleach catalyst is a manganese complex selected from 1,4,7-trimethyl-1,4,7-triazacyclo-nonane (Me3-TACN), 1,2,4,7-tetramethyl-1,4,7-triazacyclononane (Me4-TACN) and mixtures thereof.

### Bleach Activator

The composition of the method of the invention preferably comprises a bleach activator. The bleach activator is preferably part of the manganese bleach catalyst particle. As bleach activator, the composition of the method of the invention and preferably the manganese bleach catalyst particle may comprise polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acylimides, especially N-nonanoylsuccinimide (NOSI), acylated phenolsulfonates, especially n-nonanoyloxy- or n-lauroyloxybenzenesulfonate (NOBS or LOBS), acylated phenolcarboxylic acids, especially nonanoyloxy- or decanoyloxybenzoic acid (NOBA or DOBA), carboxylic anhydrides, especially phthalic anhydride, acylated polyhydric alcohols, especially triacetin, ethylene glycol diacetate and 2,5-diacetoxy-2,5-dihydrofuran, and also acylated sorbitol and mannitol or mixtures thereof (SORMAN), acylated sugar derivatives, especially pentaacetylglucose (PAG), pentaacetylfructose, tetraacetylxylose and octaacetyllactose, and also acetylated, optionally N-alkylated glucamine and gluconolactone, and/or N-acylated lactams, for example N-benzoylcaprolactam. Hydrophilically substituted acylacetals and acyllactams are likewise used with preference. In addition, it is possible to use nitrile derivatives such as n-methylmorpholinioacetonitrile methyl sulfate (MMA) or cyanomorpholine (MOR) as bleach activators. It is also possible to use combinations of conventional bleach activators. Particularly preferred bleach activators are TAED and DOBA, more in particular TAED.

### Binders

As a further constituent, the manganese bleach catalyst particle preferably comprises a binder in order to ensure the integrity of the particle. The binders used may preferably be substances selected from fatty acids, alcohol ethoxylates and polymers.

Suitable examples include organic fatty acids having 8 to 22 carbon atoms, such as lauric acid, myristic acid, stearic acid or mixtures thereof. Additionally preferred are organic polymers. The polymers may be nonionic, anionic, cationic or amphoteric in nature. Natural polymers and modified polymers of natural origin are just as usable as synthetic polymers.

Nonionic polymers used with binders includes polyvinyl alcohols, acetalized polyvinyl alcohols, polyvinylpyrrolidones and polyalkylene glycols, especially polyethylene oxides. Preferred polyvinyl alcohols and acetalized polyvinyl alcohols have molecular weights in the range from 10 000 to 100 000 g/mol, more preferably from 13 000 to 70 000 g/mol. Preferred polyethylene oxides have molar masses in the range from approx. 200 to 5 000 000 g/mol, corresponding to degrees of polymerization n of approx. 5 to >100 000.

The anionic polymers used with particular preference as binders are especially homo- or copolymeric carboxylates. Preference is given to using, for example, polyacrylic acid or polymethacrylic acid, especially those having a relative molecular mass of 500 to 70 000 g/mol.

Polyacrylates which have a molecular mass of 2 000 to 20 000 g/mol present superior solubility, preference is given in turn, from this group, to the short-chain polyacrylates which have molar masses of 2 000 to 10 000 g/mol and preferably of 3 000 to 5000 g/mol.

Among these, preference is further given to copolymeric polycarboxylates, especially those of acrylic acid with methacrylic acid and of acrylic acid or methacrylic acid with maleic acid. Particularly suitable copolymers have been found to be those of acrylic acid with maleic acid which contain 50 to 90% by weight of acrylic acid and 50 to 10% by weight of maleic acid. The relative molecular mass thereof, based on free acids, is preferably 2 000 to 70 000 g/mol, more preferably 20 000 to 50 000 g/mol and especially preferably 30 000 to 40 000 g/mol.

To improve the water solubility, the polymers may also contain structural units originating from allylsulfonic acids, for example allyloxybenzenesulfonic acid and methallylsulfonic acid. Especially preferred are also biodegradable polymers formed from more than two different monomer units, for example those which contain structural units formed from salts of acrylic acid and of maleic acid and from vinyl alcohol or vinyl alcohol derivatives and sugar derivatives, or which contain structural units formed from salts of acrylic acid and of 2-alkylallylsulfonic acid and from sugar derivatives.

Further preferred copolymers are those which have structural units originating from acrolein and acrylic acid/acrylic salts or acrolein and vinyl acetate.

Further anionic polymers used as binders with preference are sulfo-containing polymers, especially copolymers formed from unsaturated carboxylic acids, sulfo-containing monomers and optionally further ionic or nonionic monomers.

Further preferred binders are room temperature solid C8-C22 alcohol ethoxylates, preferably C8-C22 alcohol ethoxylates with an average of 10 to 100 ethylene oxide units in the molecule, for example Genapol® T 500 from Clariant or carboxymethylcelluloses.

### Organic Acids

The manganese bleach catalyst particle may comprise organic acids, preferably selected from the group consisting of citric acid, ascorbic acid, oxalic acid and mixtures thereof. The organic acid assumes a protective function and prevents the reaction of alkaline ingredients of the cleaning product with the non-alkali-resistant and hydrolysis-sensitive bleach catalyst and activator, if present.

### Process for Making the Manganese Bleach Catalyst Particle

In principle, various granulating processes are possible providing that they produce a delayed release particle as herein specified. Build-up granulation can be used, it can take place in mixing apparatuses. In this case, the components are processed in customary mixing apparatuses which work batchwise or continuously and are generally equipped with rotating mixing elements. The mixers used may be apparatuses which work under moderate conditions, for example plowshare mixers (Lodige KM models, Drais K-T models), but also intensive mixers (e.g. Eirich, Schugi, Lodige CB models, Drais K-TT models). For mixing, all mixing variants which assure sufficient mixing of the components are conceivable, probably all components are mixed simultaneously. However, also conceivable are multistage mixing operations in which the individual components are introduced in different combinations into the overall mixture, individually or together with other additives. The sequence of low- and high-speed mixers can be switched as required. The residence times in the mixer granulation are preferably 0.5 s to 20 min, more preferably 2 s to 10 min. The granulation liquid can be pumped into the mixing apparatus via simple guide tubes. For better distribution, however, nozzle systems (one-substance or multisubstance nozzles) are also conceivable.

Depending on the granulating liquid used (solvent or molten binder), the granulation stage is followed by a drying step (for solvents) or cooling step (for melts), in order to avoid conglutination of the particles. The aftertreatment preferably takes place in a fluidized bed apparatus. Subsequently, the course and fine fractions are removed by sieving. The coarse fraction is comminuted by grinding and, just like the fine fraction, sent to a new granulation operation.

Alternatively, granulation with the aid of a plasticizer can be used. The pulverulent constituents (bleach catalyst and optionally bleach activator and other processing aids) are admixed with one or more plasticizing substances. The plasticizers can be introduced as a liquid or as a melt, preference being given in accordance with the invention to molten substances. The liquid plasticizer is mixed intensively with the pulverulent active substance and optionally the further additives, so as to form a plastically deformable material. The mixing step can be effected in the abovementioned mixing apparatuses, but kneaders or specific extruder types (e.g. Extrud-o-mix from Hosokawa-Bepex Corp.) are also conceivable.

The granulation material is subsequently pressed by means of tools through the die bores of a compression die, so as to form cylinder-shaped extrudates. Suitable apparatuses for the extrusion operation are edge-runner presses (for example from Schluter, Salmatec, Buhler), pan grinders (for example from Amandus-Kahl) and extruders designed as a single-shaft machine (for example from Hosokawa-Bepex, Fuji-Paudal) or preferably as a twin-screw extruder (for example from Handle). The selection of the diameter of the die bore depends on the individual case and is typically in the range of 0.7-4 mm.

The emerging extrudates have to be comminuted to the desired length and particle size by a further processing step. In many cases, a length/diameter ratio of L/D=1 is desired. In the case of cylindrical granules, the particle diameter is between 0.2 and 2 mm, preferably between 0.5 and 0.8 mm; the particle length is in the range from 0.5 to 3.5 mm, ideally between 0.9 and 2.5 mm. The length and size of the granules can be adjusted, for example, by means of fixed stripping knives, rotating cutting knives, cutting wires or cutting blades. To round off the cut edges, the granules can subsequently be rounded once again in a rounder (for example from Glatt, Schluter, Fuji-Paudal).

After the size of the granules has been adjusted, a final consolidation step may be required, in which the solvent is removed or the melt is solidified. This step is typically conducted in a fluidized bed apparatus which, according to the requirements, is operated as a dryer or cooler. Subsequently, the coarse and fine fractions are removed by sieving. The coarse fraction is comminuted by grinding and, just like the fine fraction, sent to a new granulation operation.

Compaction is also suitable to make the manganese bleach catalyst particles. The pulverulent active substances are optionally mixed with further, preferably solid additives and this mixture is compacted, then ground and optionally sieved into individual particle fractions It is also possible to a certain extent (for example of 10% by weight) to additionally add liquid additives to the mixture. Examples of compacting aids are waterglass, polyethylene glycols, nonionic surfactants, anionic surfactants, polycarboxylate copolymers, modified and/or unmodified celluloses, bentonites, hectorites, saponites and/or other washing composition ingredients.

The compaction is preferably conducted on what are called roll compactors (for example from Hosokawa-Bepex, Alexanderwerk, Koppem). Through the selection of the roller profile, it is possible to obtain firstly pellets or briquettes and secondly pressed slugs. While the pressings in piece form typically only have to be removed from the fine fraction, the slugs have to be comminuted to the desired particle size in the mill. The mill types typically used are preferably gentle milling apparatuses, for example sieve and hammer mills (for example from Hosokawa-Alpine, Hosokawa-Bepex) or roll mills (for example from Bauermeister, BUler). The fine fraction and, if appropriate, the coarse fraction are removed from the granules thus obtained by sieving. The coarse fraction is sent back to the mill, and the fine fraction back to the compaction. For classification of the granules, it is possible to use standard sieving machines, for example tumbling sieves or vibration sieves (for example from Allgaier, Sweco, Vibra).

The manganese bleach catalyst particles can be made by an analogous process to that described in WO 2005/080542 in which a core is coated with a coating agent and a binder and the coating comprises the active, in the case of our invention, the bleach catalyst in the form of very fine particles. Preferably the bleach catalyst used to make the particles have a particle size of from about 1 to about 50 microns, more preferably from about 2 to about 20 microns and especially from about 3 to about 15 microns.

### Cleaning Product

The cleaning product for use in the method of the invention comprises a particulate loose-powder composition.

The product of the invention preferably has a pH as measured in 1% weight/volume aqueous solution in distilled water at 20° C. of from about 9 to about 12, preferably from about 10 to less than about 11.5 and more preferably from about 10.5 to about 11.5.

The product of the invention preferably has a reserve alkalinity of from about 10 to about 20, more preferably from about 12 to about 18 at a pH of 9.5 as measured in NaOH with 100 grams of product at 20° C.

### Complexing Agent

A complexing agent is a material capable of sequestering hardness ions, particularly calcium and/or magnesium. Preferably, the complexing agent is in the form of a fast release particle that delivers a considerable part of complexing agent before the manganese bleach catalyst is delivered to the wash liquor.

The product of the method of the invention comprises from 5% to 50% of complexing agent, preferably from 10 to 40% by weight of the product. The complexing agent is preferably selected from the group consisting of methyl-glycine-diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof and mixtures thereof. Especially preferred complexing agent for use herein is a salt of MGDA, in particular the tri-sodium salt of MGDA, preferably in a level of from 10 to 30% by weight of the product.

### Dispersant Polymer

The polymer, if present, is used in any suitable amount from about 0.1% to about 30%, preferably from 0.5% to about 20%, more preferably from 1% to 10% by weight of the product. Sulfonated/carboxylated polymers are particularly suitable for use herein.

### Polycarboxylate Polymer

For example, a wide variety of modified or unmodified polyacrylates, polyacrylate/maleates, or polyacrylate/methacrylates are highly useful. It is believed these polymers are excellent dispersing agents and enhance overall detergent performance, particularly when used in the composition of the invention.

Suitable polycarboxylate-based polymers include polycarboxylate polymers that may have average molecular weights of from about 500 Da to about 500,000 Da, or from about 1,000 Da to about 100,000 Da, or even from about 3,000 Da to about 80,000 Da. Suitable polycarboxylates may be selected from the group comprising polymers comprising acrylic acid such as Sokalan PA30, PA20, PA15, PA10 and sokalan CP10 (BASF GmbH, Ludwigshafen, Germany), Acusol™ 45N, 480N, 460N and 820 (sold by Rohm and Haas, Philadelphia, Pa., USA) polyacrylic acids, such as Acusol™ 445 and Acusol™ 420 (sold by Rohm and Haas, Philadelphia, Pa., USA) acrylic/maleic co-polymers, such as Acusol™ 425N and acrylic/methacrylic copolymers.

Alkoxylated polycarboxylates such as those prepared from polyacrylates are useful herein to and can provide additional grease suspension. Such materials are described in WO 91/08281 and PCT 90/01815. Chemically, these materials comprise polyacrylates having one ethoxy side-chain per every 7-8 acrylate units. The side-chains are ester-linked to the polyacrylate “backbone” to provide a “comb” polymer type structure. The molecular weight can vary, but may be in the range of about 2000 to about 50,000.

Unsaturated monomeric acids that can be polymerized to form suitable dispersing polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50% by weight of the dispersant polymer.

Co-polymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used. Most preferably, such dispersant polymer has a molecular weight of from about 4,000 to about 20,000 and an acrylamide content of from about 0% to about 15%, by weight of the polymer.

### Sulfonated Polymers

Suitable sulfonated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000, and specially from about 5,000 Da to about 45,000 Da.

The sulfonated polymers preferably comprises carboxylic acid monomers and sulfonated monomers. Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or α-methyl styrene.

Specially preferred sulfonated polymers for use herein are those comprising monomers of acrylic acid and monomers of 2-acrylamido-methyl propane sulfonic acid.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas, Versaflex Si™ (sold by Alco Chemical, Tennessee, USA) and those described in U.S. Pat. No. 5,308,532 and in WO 2005/090541.

Suitable styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tennessee, USA, under the tradenames Alcosperse® 729 and 747.

Other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates, the dextrin esters of polycarboxylic acids disclosed in U.S. Pat. No. 3,929,107, Thompson, issued Nov. 11, 1975; the hydroxyalkyl starch ethers, starch esters, oxidized starches, dextrins and starch hydrolysates described in U.S. Pat No. 3,803,285, Jensen, issued Apr. 9, 1974; the carboxylated starches described in U.S. Pat. No. 3,629,121, Eldib, issued Dec. 21, 1971; and the dextrin starches described in U.S. Pat. No. 4,141,841, McDonald, issued Feb. 27, 1979.

Preferred cellulose-derived dispersant polymers are the carboxymethyl celluloses.

Yet another group of acceptable dispersing agents are the organic dispersing polymers, such as polyaspartates.

Amphilic graft co-polymer are useful for use herein. Suitable amphilic graft co-polymer comprises (i) polyethylene glycol backbone; and (ii) and at least one pendant moiety selected from polyvinyl acetate, polyvinyl alcohol and mixtures thereof. In other examples, the amphilic graft copolymer is Sokalan HP22, supplied from BASF.

### Bleach

Preferably, the level of bleach in the product of the method of the invention is from about 1 to about 20%, more preferably from about 2 to about 15%, even more preferably from about 3 to about 12% and especially from about 4 to about 10% by weight of the composition.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Inorganic Builder

The product of the method of the invention preferably comprises an inorganic builder. Suitable inorganic builders are selected from the group consisting of carbonate, silicate and mixtures thereof. Especially preferred for use herein is sodium carbonate. Preferably the product of the method of the invention comprises from 5 to 50%, more preferably from 10 to 40% and especially from 15 to 30% by weight of the product.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide. Surfactants may be present in amounts from 0 to 15% by weight, preferably from 0.1% to 10%, and most preferably from 0.25% to 8% by weight of the product.

### Enzymes

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, S130A, Y167A, R170S, A194P, V205I and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+S130A
(iii) N76D+N87R+G118R+S128L+P129Q+S130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the product of the invention include from about 0.1 to about 10, more preferably from about 0.5 to about 5 and especially from about 1 to about 4 mg of active protease per grams of product.

### Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp.707 (SEQ ID NO:7 in U.S. Pat. No. 6,093, 562), especially those comprising one or more of the following mutations M202, M208, S255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

Preferably, the product of the invention comprises at least 0.01 mg of active amylase per gram of composition, preferably from about 0.05 to about 10, more preferably from about 0.1 to about 6, especially from about 0.2 to about 4 mg of amylase per gram of composition.

### Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

### Cellulases

The product of the invention preferably comprises other enzymes in addition to the protease and/or amylase. Cellulase enzymes are preferred additional enzymes, particularly microbial-derived endoglucanases exhibiting endo-beta-1,4-glucanase activity (E.C. 3.2.1.4). Preferred commercially available cellulases for use herein are Celluzyme®, Celluclean®, Whitezyme® (Novozymes A/S) and Puradax HA® and Puradax® (Genencor International).

Preferably, the protease and/or amylase of the product of the invention are in the form of granulates, the granulates comprise less than 29% of sodium sulfate by weight of the granulate or the sodium sulfate and the active enzyme (protease and/or amylase) are in a weight ratio of less than 4:1.

### Crystal Growth Inhibitor

Crystal growth inhibitors are materials that can bind to calcium carbonate crystals and prevent further growth of species such as aragonite and calcite. Especially preferred crystal growth inhibitor for use herein is HEDP (1-hydroxyethylidene 1,1-diphosphonic acid). Preferably, the composition of the invention comprises from 0.01 to 5%, more preferably from 0.05 to 3% and especially from 0.5 to 2% of a crystal growth inhibitor by weight of the product, preferably HEDP.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and specially from 0.3 to 3% by weight of the product of a metal care agent, preferably the metal care agent is benzo triazole (BTA).

### Glass Care Agents

Glass care agents protect the appearance of glass items during the dishwashing process. Preferably the composition of the invention comprises from 0.1 to 5%, more preferably from 0.2 to 4% and specially from 0.3 to 3% by weight of the composition of a metal care agent, preferably the glass care agent is a zinc containing material, specially hydrozincite.

Preferably the product for use in the method of the invention is presented in unit-dose form. Products in unit dose form include capsules, sachets, pouches, injection moulded containers, etc. Preferably, the composition is in a pack made of water-soluble material. Preferred packs are pouches, where the detergent composition is enveloped by a water-soluble film and injection moulded containers wherein the detergent composition is presented in a container of water-soluble material made by injection moulding. Both the detergent composition and the enveloping material are water-soluble. They dissolve when exposed to water in an automatic dishwashing process, preferably during the main wash. The pack can have a single compartment or a plurality of compartments. The compartments can comprise a composition in liquid or solid form. Preferred herein are multi-compartment pouches.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

### EXAMPLES

Two dual-compartment automatic dishwashing pouches were made comprising the ingredients detailed herein below (Composition 1 (comparative) and Composition 2 (according to the invention)). The pouches were made of polyvinyl alcohol with the solid and liquid components in different compartments.

| Ingredients (grams of active | | |
|---|---|---|
| material) | Composition 1 | Composition 2 |
| Solid compartment | | |
| Sodium carbonate | 5.00 | 5.00 |
| MGDA | 4.20 | 4.20 |
| Sodium percarbonate | 3.00 | 3.00 |
| Acusol 588 | 1.20 | 1.20 |
| TAED | 0.60 | 0.40 |
| HEDP | 0.10 | 0.10 |
| Protease | 0.034 | 0.034 |
| Amylase | 0.003 | 0.003 |
| MnTACN | 0.0075 | — |
| MnTACN particle | — | 0.377 |
| MnTACN | | 0.0075 |
| Zinc carbonate | | 0.0096 |
| TAED | | 0.20 |
| Miscellaneous | | 0.16 |
| Miscellaneous | balance to 17.5 | balance to 17.5 |
| Liquid compartment | | |
| Lutensol TO7 | 0.90 | 0.90 |
| Plurafac SLF-180 | 0.80 | 0.80 |
| Miscellaneous | balance to 2.18 | balance to 2.18 |

MGDA Tri sodium salt of methyl glycine diacetic acid.
Acusol 588 Sulphonated polycarboxylate supplied by Rohm & Haas
Amylase Stainzyme plus ®
Protease Ultimase ®
TAED Tetraacetylethylenediamine
HEDP 1-hydroxyethylidene 1,1-diphosphonic acid
MnTACN particle Delayed release particle (dissolution profile below)
Plurafac SLF-180 Nonionic surfactant supplied by BASF
Lutensol TO7 Nonionic surfactant supplied by BASF

### Performance Data

Eight cups per test leg were stained using black tea (Assam) prepared in artificially hard water with ferric sulphate as per IKW test method, (IKW working group automatic dishwasher detergents. “Methods for Ascertaining the Cleaning Performance of Dishwasher Detergents, (Part B, updated 2005)”. SÖFW-Journal, 132, 8-2006 pp. 35). For each formula, two cups were placed on the top rack of a washing machine, loaded with ballast dishes, and washed using composition 1 and 2. The inlet water had a hardness of 360 ppm of CaCO₃.

As artificial ballast soil 100 g of IKW soil from frozen and 36 g of minced meat were added from frozen. Artificial IKW soil was prepared according to the IKW procedure and the meat soil was prepared by mixing 225 g of minced meat (50% pork and 50% beef), 75 g of eggs (white and yolk) and 80 g of water (350 CaCO3 ppm hardness), and blending it until forming a paste, then it is divided in pots containing 36 g of the minced meat paste each and stored in a freezer.

The test was carried out in a Miele GSL dishwashing machine in a normal R-50° C. cycle (no pre-wash). The detergent is added to the dishwasher when the dispenser door opens. The test was repeated three more times with the remaining cups, once all of them were washed the eight cups were graded by three independent judges, using a visual scale from 1 to 10 going from soiled to completely clean.

| | Grader 1 | | Grader 2 | | Grader 3 | | All Graders: | |
|---|---|---|---|---|---|---|---|---|
| | N | Mean | N | Mean | N | Mean | N | Mean |
| Composition 1 | 8 | 2.56 | 8 | 2.38 | 8 | 2.75 | 8 | 2.56 |
| Composition 2 | 8 | 4.56 | 8 | 5.13 | 8 | 4.38 | 8 | 4.69s |

The removal of tea stains using the composition comprising the manganese bleach catalyst delayed release particle is considerably higher than the removal obtained by a composition comprising the same amount of manganese bleach catalyst but in powder form.

### Dissolution Profile of the Powder Sections of Composition 1 and 2

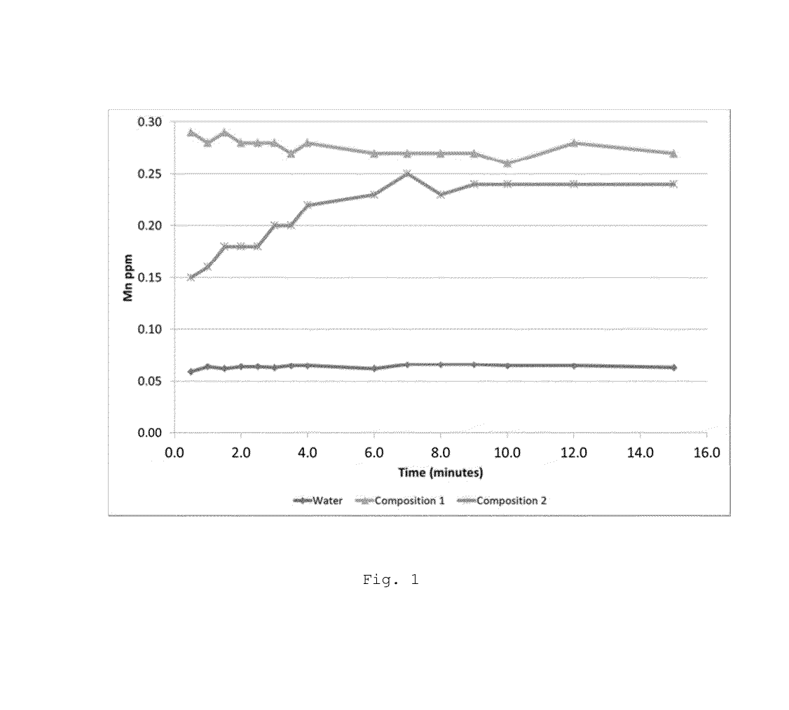

To determine the dissolution profile of the MnTACN, the manganese concentration through the wash was measured. The powder section of composition 1 (comparative) and composition 2 (according to the invention) were dissolved in a dishwashing machine running a normal 50° C. cycle using inlet water with 360 CaCO₃ ppm of hardness. Aliquots were taken at different intervals, using a sampling tube to avoid opening the dishwasher, filtered and analysed for Mn concentration using inductively coupled plasma mass spectrometry (Water sample analysis carried out in Northumbria Water Scientific Services), the manganese concentration in water was also measured as shown in FIG. 1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of automatic dishwashing comprising the step of delivering into a dishwasher a cleaning product comprising a particulate loose-powder composition comprising an organic complexing agent, bleach, manganese bleach catalyst and free of phosphate and wherein the manganese bleach catalyst is in the form of a delayed release particle.

2. A method according to claim 1 wherein the complexing agent is selected from the group consisting of methyl glycine diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof, and mixtures thereof.

3. A method according to claim 1 wherein the complexing agent is selected from the group consisting of methyl glycine diacetic acid, its salts and derivatives thereof.

4. A method according to claim 1 wherein the complexing agent is in the form of a fast dissolving particle.

5. A method according to claim 1 wherein the composition comprises a bleach activator.

6. A method according to claim 1 wherein the composition comprises a glass care agent.

7. A method according to claim 1 wherein the manganese bleach catalyst particle comprises a bleach activator.

8. A method according to claim 1 wherein the manganese bleach catalyst particle comprises the glass care agent.

9. A method according to claim 1 wherein the bleach catalyst particle comprises from about 5% to about 5% of catalyst by weight of the particle.

10. A method according to claim 1 wherein the composition comprises from about 5% to about 20% of bleach catalyst particles by weight of the composition.

11. A method according to claim 1 wherein the bleach catalyst is a manganese complex selected from 1,4,7-trimethyl-1,4,7-triazacyclo-nonane (Me3-TACN), 1,2,4,7-tetramethyl-1,4,7-triazacyclononane (Me4-TACN) and mixtures thereof.

12. A method according to claim 1 wherein the composition comprises from about 5% to about 20% of bleach by weight of the composition, wherein the bleach is percarbonate bleach.

13. A method according to claim 1 wherein the composition comprises a dispersant polymer.

14. A method according to claim 1 wherein the loose powder is in unit-dose form enveloped by a water-soluble material.

15. ,A method according to claim 1 wherein the loose powder is in unit-dose form enveloped by a water-soluble material wherein the water-soluble material is a polyvinyl-alcohol based water-soluble film of less than 100 μm thickness.

16. A method according to claim 1 wherein the product is in the form of a multi-compartment water-soluble pouch.
